(19) United States
(12) Patent Application Publication
(10) Pub. No.: US 2025/0269417 A1
(43) Pub. Date: Aug. 28, 2025

(54) METHOD FOR PRODUCING A TOOL, TOOL, METHOD FOR MACHINING A WORKPIECE, WORKPIECE

(71) Applicant: Surfunction GmbH, Saarbruecken (DE)

(72) Inventors: Dominik BRITZ, Wallerfangen (DE); Daniel Wyn MUELLER, Saarbruecken (DE); Frank MUECKLICH, Schwalbach (DE); Philipp GRUETZMACHER, Wien (AT); Paul BRAUN, Darmstadt (DE); Karsten DURST, Darmstadt (DE)

(73) Assignee: Surfunction GmbH, Saarbruecken (DE)

(21) Appl. No.: 19/203,473

(22) Filed: May 9, 2025

Related U.S. Application Data
(63) Continuation of application No. PCT/EP2023/081157, filed on Nov. 8, 2023.

(30) Foreign Application Priority Data
Nov. 9, 2022 (DE) 10 2022 129 623.7
Nov. 9, 2022 (DE) 20 2022 106 292.7

(51) Int. Cl. B21D 37/20

(52) U.S. Cl. CPC B21D 37/20

(57) ABSTRACT

A method for producing a tool for machining a workpiece. A metal tool blank is provided in a laser machining device which structures the tool blank on a tool surface via interference from at least two laser beams. The at least two laser beams have at least temporary pulse durations of at most 15 ps, and via the structuring on the tool surface a tool profile is generated having at least one indentation. A tool structured in this manner, a method for machining a workpiece via the tool, and a workpiece machined in this way, are also provided.

This nonprovisional application is a continuation of International Application No. PCT/EP2023/081157, which was filed on Nov. 8, 2023, and which claims priority to German Patent Application No. 10 2022 129 623.7, which was filed in Germany on Nov. 9, 2022, and to German Patent Application No. 20 2022 106 292.7 which was filed in Germany on Nov. 9, 2022, which are herein incorporated by reference.

### BACKGROUND OF THE INVENTION

### Field of the Invention

The invention relates to a method for producing a tool for machining a workpiece, and to a tool. In addition, the invention relates to a method for machining a workpiece and to a workpiece.

### Description of the Background Art

An object addressed by the invention is that of at least partially structuring a workpiece, in particular a metal workpiece such as a component, with a topography in the lower micrometer and/or nanometer range. A variety of biological surfaces have structuring of this order of magnitude, each producing its very own unique functional surface properties, such as altered wetting (lotus, thorny devil), color effects (butterfly wing scales), reduced friction (shark skin), reduced adhesion/active killing of germs and pathogens (wings of cicada and dragonfly). Topographies of this order of magnitude are therefore also called biomimetic topographies. Many of these surface properties are influenced not only by the topography of the surface itself but also by the surface chemistry.

Within the context of industrial surface structuring of workpieces with topographies of the above-mentioned order of magnitude, it is currently only possible to machine the workpieces directly using at least two laser beams that interfere with one another. Due to this substantially thermal type of machining, the surface of the workpiece is not only topographically modified but also chemically modified during machining, which can counteract the desired function or any further processing of the workpiece. In this respect, the desired functionalization of the workpiece surface by being directly machined by the interfering laser beams cannot always be guaranteed, especially in the case of metal tools, since the thermal effect of the laser radiation is particularly pronounced here due to the electromagnetic absorption properties of metals.

### SUMMARY OF THE INVENTION

It is therefore an object of the invention to develop a method for producing a tool, with which improved surface topography of the workpiece can be produced in industrial applications, in particular with which micro- and/or nanoscale topographic surface functionalization of the workpiece can be realized, which enables more design options while having a reduced thermal and chemical effect on the workpiece compared to direct machining via laser interference. The same applies to the tool produced using the method mentioned, to the method carried out using the tool for machining a workpiece and to the workpiece itself machined in this respect.

The method according to the invention for producing a tool for machining a workpiece provides that a metal tool blank is provided in a laser machining device and the laser machining device structures a tool surface of the tool blank via interference of at least two laser beams, wherein the at least two laser beams have at least temporary pulse durations of at most 15 ps and wherein a tool profile having at least one indentation is produced on the tool surface by the structuring. The tool according to the invention is structured in accordance with the method according to the invention.

The method according to the invention for machining a workpiece via a tool provides that the tool is structured in accordance with the method according to the invention, in particular in that the tool is a tool according to the invention. The method according to the invention for machining the workpiece further provides that the workpiece is plastically deformed, at least in some regions, via the tool and is thereby provided with a workpiece profile which corresponds to the tool profile, at least in some regions. The workpiece according to the invention is machined in accordance with the method according to the invention.

The invention is based on the basic concept that, in contrast to the already known process of directly structuring the workpiece via the interfering laser radiation, the tool is now first produced by the structuring described and then, in a subsequent step, the workpiece itself can be structured. The essential core of the invention is that an interaction between the laser radiation and the workpiece surface to be ultimately structured is avoided such that the disadvantageous chemical modification of the workpiece surface known from the prior art is avoided, but its desired functionality is retained or can be guaranteed in the first place. The invention produces the structuring of the workpiece surface, in particular a metal substrate surface, for example in the lower micro- and/or nanometer range by plastic deformation, which does not affect the surface chemistry. Thus, only the topography of the metal substrate is modified without affecting the basic chemical interaction with contacting substances, e.g. wetting by water or oils. The present invention makes purely topographical surface functionalization, which was previously not feasible, accessible for industrial application, which is particularly suitable for further processing of the surfaces via electroplating, PVD (Physical Vapor Deposition), etc.

Investigations by the applicant have shown that the substantially plastic machining of the workpiece carried out within the scope of the invention does not result in any significant chemical modification of the workpiece, as has so far been necessary with the methods known from the prior art. For example, according to studies by the applicant, it has been found that the wetting properties of a workpiece machined according to the invention differ significantly from the wetting properties of a workpiece machined via direct laser interference structuring, which can be attributed to the avoidance of any chemical surface modification in the case of the invention.

A further basic concept of the invention is that by using laser beams that interfere with one another to produce the tool by structuring it, a large tool surface can be machined in a short time and therefore the process efficiency of the method according to the invention is improved. In particular, the tool can be provided with structuring in the micro- and/or nanometer scale range over the entire surface thereof within a short machining time, which leads to significantly higher process efficiency and thus lower tool costs compared to other existing high-precision machining methods, such as focused laser or ion radiation. This advantage is particularly evident when compared to structuring the tool with just a single laser beam, which has to be laboriously directed along the entire tool surface to be structured, making the method arduous and slow.

Further advantages over directly structuring the workpieces also include, in particular, a greater variety of possible topographic geometries of the workpieces, for example through partial molding with low contact pressure and repeated stamping with variable structuring of the tool, as well as the shorter processing time for structures that are deep or have an aspect ratio. In particular, the latter structural form can sometimes lead to very long processing times in a purely ablative laser method, whereas stamping can achieve this in one stroke.

Since the workpiece is machined using the structured tool and no longer directly using laser radiation as in known methods, a significant improvement in occupational safety in industrial applications is also achieved.

By using laser pulses with a temporal pulse duration of at most 15 ps as per the invention, thermal effects during the interaction between the laser radiation and the tool surface are largely avoided, which in particular prevents the occurrence of melting and thermally induced material damage, in particular stress cracks. It is known that with shorter pulse durations, thermal effects are increasingly neglected and the tool is increasingly mechanically machined. This effect is therefore also called cold ablation. From this point of view, it can be provided that the temporal pulse duration of the laser beams is at most 10 ps so that even fewer thermal effects occur. In addition, the accuracy of the structure is improved. For the same reason, it is most preferable that the temporal pulse duration of the laser radiation is at most 1 ps, whereby an even better surface quality of the tool structuring can be obtained. Preferably, a temporal pulse duration between 100 fs and 15 ps, in particular between 100 fs and 1 ps, is provided. Furthermore, the power of the laser radiation can be between 1 W and 500 W and/or the energy of the laser radiation pulses can be between 10 μJ and 100 mJ. When creating the structuring as per the invention, between 10 and 1000 individual pulses can be superimposed in a spatial region in order to obtain high structural aspect ratios via correspondingly high material removal.

Furthermore, it can be provided that exactly two laser beams that interfere with one another are used to structure the tool. A development of the invention provides for the use of three laser beams that interfere with one another, whereby, for example, the tool can be structured having indentations in a hexagonal pattern. In this case, the structuring has three axes along the surface, along which the indentations are each arranged in a lateral period, wherein, within the sense of the invention, each of the lateral periods for the three axes in the hexagonal pattern are identical. In addition, four laser beams that interfere with one another can be used to create a square pattern of indentations when structuring the tool. Finally, it may be provided that a maximum of nine laser beams that interfere with one another are used.

The tool may be a punching or forming tool, wherein the workpiece may accordingly be machined using a punching or forming method, in particular a stamping method.

Preferably, the at least one indentation is produced having a dimension, in particular a depth relative to an unstructured region of the tool surface, of between 10 nm and 50 μm, in particular between 100 nm and 15 μm. In further examples of the invention, it can be provided that the dimension of the indentation corresponds to its length in the x and/or y direction, wherein, within the sense of the invention, in the case of a plurality of indentations the y direction corresponds to the direction in which the indentations are offset, while the x direction is perpendicular thereto. The x and y directions are each perpendicular to the normal of the tool surface and thus each extend along the tool surface. Within the sense of the invention, the dimension can also be a combination of the x and y direction, which in this respect generally corresponds to a lateral direction.

Preferably, at least two indentations can be produced having substantially identical dimensions, in particular substantially identical depths. Within the sense of the invention, two dimensions have substantially identical dimensions if the deviations therefrom do not exceed the machining tolerance that is customary in similar methods. At least two adjacent indentations can be arranged at a distance of 10 nm to 50 μm, in particular 100 nm to 15 μm. The tool, which is structured in this way, enables structural geometries of an order of magnitude between 10 nm and 50 μm, in particular between 100 nm and 15 μm, to be realized on the workpiece at an industrially relevant processing speed while at the same time ensuring reproducibility.

Preferably, at least one group of indentations can be produced in a periodic pattern on the tool surface, since this structure can be produced particularly easily via the laser beams that interfere with one another. Within the context of the present invention, the period refers to the distance between two identical structural features of different indentations of the periodic pattern, i.e. for example the distance between the beginning of a first indentation of the periodic pattern and the beginning of the adjacent indentation of the same periodic pattern. Alternatively or additionally, within the sense of the invention, the period can denote the distance between a center point of the first indentation of the periodic pattern and the center point of the adjacent indentation of the same periodic pattern. Since the indentations of the periodic pattern are laterally offset, the invention also refers to the lateral period, which, as already mentioned, refers to the distance between recurring structural features of adjacent indentations of the periodic pattern.

In an advantageous development of the invention, it can be provided that the group of indentations in the periodic pattern on the tool surface can be produced having a period between 10 nm and 50 μm, in particular between 100 nm and 15 μm, in at least one direction along the tool surface. Periodic structuring with a lateral period of this order of magnitude allows for the formation of the advantageous surface functionalities mentioned at the outset, which the workpiece is ultimately also to be provided with. Furthermore, the group of indentations in the periodic pattern can have different periods in different directions, for example when three, four or more laser beams that interfere with one another are used to structure the tool. In an advantageous development, the group of indentations has identical periods in two different directions in the periodic pattern. Furthermore, it can be provided that the group of indentations has identical periods in three different directions in the periodic pattern, which corresponds, for example, to a hexagonal arrangement of the indentations. The group of indentations is formed, for example, as a sinusoidal line structure in which indentations and elevations are arranged one behind the other in the same lateral period each time.

Preferably, at least one group of indentations can be produced on the tool surface having a linear course and/or a rectangular, preferably square, basic shape and/or a circular basic shape. The basic shape of the indentations can be polygonal, in particular hexagonal. As a special case, the indentations can be designed as lines, which can be arranged in particular so as to be offset perpendicularly to the direction of extension and/or having a defined period.

It is preferably provided that at least two first indentations, in particular a first group of indentations, can be produced having a first lateral period between 10 nm and 50 μm, in particular between 100 nm and 15 μm, and at least two second indentations, in particular a second group of indentations, are produced having a second lateral period, the second lateral period in particular being smaller than the first lateral period. The first lateral period can be between 100 nm and 999 μm. However, the second lateral period can also be larger than or identical to the first lateral period. The second group of indentations may be mathematically similar to the first group of indentations such that the second group of indentations results from the first group of indentations via at least one mathematical similarity transformation, for example translation, rotation, dilation and/or scaling. Preferably, the second group of indentations corresponds to a rotation of the first group of indentations of 90° about an axis perpendicular to the tool surface.

Alternatively or additionally, it can be provided that at least two first indentations, in particular a first group of indentations, can be produced having a first dimension between 10 nm and 50 μm, in particular between 100 nm and 15 μm, and at least two second indentations, in particular a second group of indentations, are produced having a second dimension, wherein the second dimension is in particular smaller than the first dimension. As already stated, within the meaning of the invention, the dimension of the indentation may correspond to its depth.

In addition, it can be provided that, in addition to the second indentations, at least two third indentations, in particular a third group of indentations, can be produced having a third lateral period and/or a third dimension, wherein the third lateral period and/or the third dimension is/are in particular smaller than the second lateral period and/or the second dimension. In developments, up to ten groups of indentations can be created, each with a lateral period and/or a dimension, wherein in particular the lateral period and/or the dimension of a group is/are always smaller than the lateral period and/or the dimensions of the previous groups.

Preferably, the region of the second indentations, in particular of the second group of indentations, at least partially may overlap the region of the first indentations, in particular of the first group of indentations. The same applies to any third indentations that are created, in particular the third group of indentations. Such an overlap makes it possible to combine structures with different lateral periods and/or dimensions, in particular to modulate them in a mathematical sense, and to provide the tool with complex surface structures that are not possible with simple structuring. This expands the surface functionalization possibilities for the tool, and thus also for the workpiece.

Preferably, the first indentations, in particular the first group of indentations, and the second indentations, in particular the second group of indentations, can be created in a single work step or in separate work steps. The creation of the first indentations and the second indentations in a single work step results in an increase in processing speed. In contrast, the configuration in which the first indentations and the second indentations are created in separate work steps includes, in particular, the fact that the tool surface is structured with different interference patterns. For example, it can be provided that the tool is moved between two work steps. Preferably, it can be provided that the tool rotates between two work steps, in particular by 90°, for example about an axis of extension of the tool, so that indentations can be formed particularly easily, for example as cross structure patterns and/or so-called Penrose structure patterns. The indentations of the second group may be arranged perpendicularly to the indentations of the first group such that the lateral period of the second group of indentations is perpendicular to the lateral period of the first group of indentations. In addition, the lateral period of the second group of indentations can be parallel to the lateral period of the first group of indentations or can form an angle between 0° and 180°.

Preferably, the second group of indentations can be created by a polarization of the laser beams selected on the basis of the material of the tool to be structured, whereby in particular laser-induced periodic surface structuring can be formed, in particular in a joint work step together with the formation of the first group of indentations. For example, the lateral period of the second group of indentations corresponds at most to the laser beam wavelength used. The polarization of the laser beams can be linear, wherein the polarization vector is substantially perpendicular to the direction of extension of the laser-induced periodic surface structuring and/or parallel to the lateral period associated with the laser-induced periodic surface structuring. In addition, the direction of the polarization vector of the laser beams can be at an angle of between 0° and 180° relative to the lateral period of the first group of indentations so that the arrangement of the second group of indentations, in particular relative to the first group of indentations, can be adjusted by orienting the polarization vector of the laser beams.

For example, it can be provided that the first indentations, in particular the first group of indentations, can be produced via interference of the at least two laser beams, the second indentations, in particular the second group of indentations, being created via interference of at least two laser beams and/or via a single laser beam. This means that the first indentations are always created by the laser beams that interfere with one another, while this does not necessarily have to be the case when creating the second indentations. The creation of the second indentations via a single laser beam can be useful if the number of second indentations is small compared to the number of first indentations and/or if the region of the second indentations is small compared to the region of the first indentations. If the second indentations are also created via laser beams that interfere with one another, it can be provided that the number of laser beams interfering with one another differs from or is identical to when creating the first indentations.

Preferably, the tool blank can be coated before being structured and/or the tool is coated after being structured, for example with a hard material layer, in particular with a carbon layer. Most preferably, an amorphous carbon layer is used as the coating. After structuring the tool, further surface functionalization can be carried out, for example via thermal methods and/or by chemical vapor deposition (CVD) and/or by physical vapor deposition (PVD), in order to smooth the surface of the tool, for example, by removing unwanted substructures or roughness. In a further example, it can be provided that the tool surface is polished before being structured.

The tool can have at least one component made of a hard metal having a plurality of hard material particles and a binder matrix. Hard metals are metal matrix composite materials, also referred to as hard metal composite materials. The hard material particles present in the hard metal contain at least one member from the group of diamond, nitride, carbide, oxide and have a comparatively high hardness but a comparatively low toughness. For better processability, the hard material particles are therefore embedded in a binder matrix that contains at least one member from the group of cobalt, nickel, molybdenum or a combination thereof and that increases the ductility of the resulting hard metal. Hard metals are harder than pure metals, alloys and hardened steels and therefore have higher wear resistance, which also applies to the tool comprising a hard metal component.

The metal tool blank can comprise or consist of a component made of a hard metal composite, which, for example, comprises a ceramic-metal composite. Preferably, the tool blank comprises a component of tungsten carbide-cobalt hard metal (WC—Co), which optionally can contain components of vanadium carbide (VC), chromium carbide (Cr₃C₂) and/or tantalum-niobium carbide. The tool may have a coating made of a hard metal material and/or diamond and/or amorphous carbon.

Alternatively or additionally, the tool can have at least one component made of a thermally treated tool steel. The choice of thermal treatment means the properties of the tool steel can be adapted to the application of the tool. For example, the tool has a component made of quenched and tempered tool steel.

The tool can have a hard material layer, preferably a carbon layer, most preferably a tetrahedral, hydrogen-free carbon layer, at least in some regions of the tool surface. In particular, the tool surface has an amorphous carbon layer, which is also referred to as DLC (diamond-like carbon). Alternatively or additionally, the carbon layer may comprise a graphite layer and/or a diamond layer. By forming a carbon layer on the tool surface, the surface of the tool can be further functionalized; in particular, the friction and wear properties of the tool can be optimized for tribological applications.

The method according to the invention for machining the workpiece can provide that the workpiece is plastically deformed by pushing or pressing the tool onto the workpiece, in particular with a user-defined press-in depth and/or with a user-defined press-in pressure. In this respect, the resulting workpiece profile is created by pressing, pushing or stamping. The tool according to the invention can be integrated into an industrial press. Due to the simple process design via adjusting the press-in pressure, the structural depth and/or the structural geometry of the workpiece profile can be varied very easily and efficiently, which is of great interest especially for tribological applications. In addition, by adjusting the press-in pressure, variable aspect ratios can be achieved alongside negligible changes in processing times when structuring the workpiece. The workpiece profile is in particular at least partially mathematically similar to, for example at least partially complementary to, the tool profile, which, within the sense of the invention, includes the fact that the workpiece profile corresponds at least to a partial negative impression of the tool profile. In particular, the workpiece profile is an at least partial, in particular complete, impression of the tool profile. Since the geometry of the tool structuring is used when machining the workpiece, substantially identical structures can be created on different workpiece materials. Preferably, the workpiece to be machined is fed to the tool, in particular via a belt guide.

An advantageous development of the invention can provide that the workpiece is plastically deformed, at least in the region assigned to the tool, in a single machining step, whereby the workpiece profile is provided with a structure that is at least partially complementary to the tool profile. The workpiece can be completely machined by gradually moving the tool laterally relative to the workpiece surface after a machining step and then machining the workpiece again in a machining step.

Preferably, the workpiece is plastically deformed via the tool in, for example, at least two machining steps, the tool plastically deforming the workpiece along a machining axis with a first machining depth in a first machining step and, in a second machining step, the tool plastically deforming the workpiece along the machining axis with a second machining depth and the first machining depth in particular differing from the second machining depth. In particular, the second machining depth is smaller than the first machining depth. A plurality of machining steps with corresponding machining depths can be provided, wherein the machining depth of one machining step is in particular smaller than the machining depth of the previous machining step. The machining axis is preferably perpendicular to the workpiece surface. By repeatedly machining the workpiece with different machining depths, which correspond, for example, to press-in depths, complex workpiece topographies can be produced that cannot be manufactured in a single machining step. In an example of the invention, the second machining depth may be identical to the first machining depth. It may be provided that the same tool is used in two machining steps, wherein the tool is moved in a translational and/or rotational manner between the two machining steps. Preferably, the tool is moved by 90° between the two rotation steps, in particular about an axis of extension of the tool. In a further example of the invention, the tool is gradually moved in a translational manner, in particular between the machining steps, over the entire region of the workpiece to be structured. A suitable tool guide can be designed for this purpose, for example.

Preferably, the first machining step can be carried out using a first tool and the second machining step is carried out using a second tool, the first tool and/or the second tool having been produced using the method according to the invention. Preferably, both tools were produced using the method according to the invention. In a development of the invention, it can be provided that the structuring of the tool surfaces of the tools differ from one another, at least in some regions. By machining the workpiece using two different tools, in particular at two different or even identical machining depths, complex surface topographies can be produced, such as surface topographies that correspond to combinations, in particular in a mathematical sense modulations of topographies of different orders of magnitude. In addition, further machining steps using tools can be provided, wherein the tools were preferably produced using the method according to the invention.

Preferably, the second tool can have a periodic structure with a lateral period which is in particular smaller than the lateral period of the periodic structure of the first tool, which, within the sense of the invention, comprises the dimensions of the structure as well as its lateral period. In particular, it is provided that the periodic structure of the second tool has a smaller lateral period than the periodic structure of the first tool. The lateral period of the periodic structure of the second tool can also be greater than or identical to the lateral period of the periodic structure of the first tool.

It is preferably provided that the press-in pressure in one machining step differs from the press-in pressure in another machining step in order, for example, to provide the workpiece with a complex surface topography even using the structuring of a single tool. The press-in pressure used is preferably between 100 MPa and 100,000 MPa, wherein the specific press-in pressure used is to be selected on the basis of the mechanical strength of the workpiece to be machined. In a further example of the invention, the press-in pressure in one machining step is identical to the press-in pressure in another machining step.

The workpiece can be plastically deformed via a vibrational movement of the tool, in particular along the machining axis. The frequency of the vibration is preferably between 20 kHz and 10 GHz and is therefore in the ultrasonic range. Findings by the applicant have shown that the vibration of the tool during the pressing method reduces the springback of the workpiece material so that the structuring of the tool is molded onto the workpiece more effectively.

Preferably, the workpiece can be machined via the tool at a temperature of at most 1200° C., in particular without any heat being externally input.

Preferably, the workpiece according to the invention can have a structuring which is at least partially similar, in particular at least partially complementary, to the structuring of the tool.

The workpiece can comprise, for example, a component made of brass (CuZn) with in particular a zinc content of substantially 30% (CuZn30), which has a particularly pronounced degree of plastic deformability.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematically illustrated example of the method according to the invention for producing a tool and a tool according to the invention,

FIG. 2 shows a schematically illustrated example of the method according to the invention for machining a workpiece and a workpiece according to the invention,

FIG. 3 shows an example of the method according to the invention for producing a tool and a tool according to the invention,

FIG. 4 shows an example of the method according to the invention for machining a workpiece and a workpiece according to the invention,

FIG. 5 shows an example of the method according to the invention for producing a tool and a tool according to the invention,

FIG. 6 shows an example of the method according to the invention for machining a workpiece and a workpiece according to the invention,

FIG. 7 shows an example of the method according to the invention for producing a tool and a tool according to the invention,

FIG. 8 shows an example of the method according to the invention for machining a workpiece and a workpiece according to the invention,

FIG. 9 shows an example of the method according to the invention for producing a tool and a tool according to the invention,

FIG. 10 shows an example of the method according to the invention for machining a workpiece and a workpiece according to the invention,

FIGS. 11 to 14 show examples of the method according to the invention for producing a tool, of the tool according to the invention, as well as a further example of the method according to the invention for machining a workpiece and of the workpiece according to the invention,

FIGS. 15 and 16 show an example of the method according to the invention for machining a workpiece and of the workpiece according to the invention, and

FIGS. 17 and 18 show an example of the method according to the invention for machining a workpiece and of the workpiece according to the invention.

### DETAILED DESCRIPTION

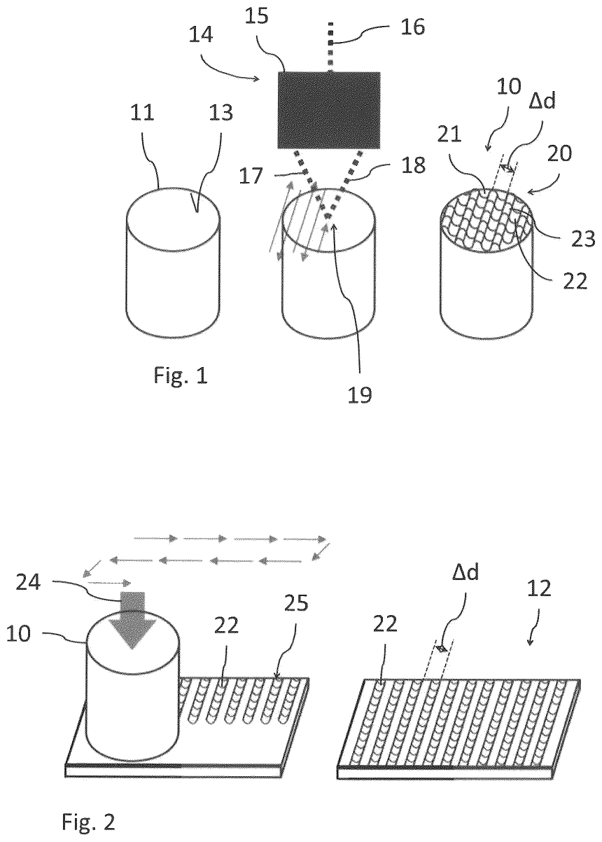

FIG. 1 shows an example of the method according to the invention for producing a tool 10 using three images of the tool 10. In the left-hand illustration in FIG. 1, the tool 10 is arranged in an unmachined state as a tool blank 11, which, in the example shown, is substantially a cylinder made of a tungsten carbide-cobalt hard metal (WC—Co) and was manufactured via spark erosion. The workpiece 12 is to be subsequently machined by the top surface 13 of the tool 10 so that the top surface 13 of the tool blank 11 is provided with a coating made of an amorphous carbon, which is also referred to as diamond-like carbon (DLC).

For the production of the tool 10 according to the invention, the tool blank 11 is provided in a laser machining device 14, which is shown only schematically in the central illustration of FIG. 1 for reasons of clarity. The laser machining device 14 has an optics module 15 which, in the example shown in FIG. 1, splits an incident laser beam into two partial beams 17, 18 and directs them in the direction of the top surface 13 of the tool blank 11 to be structured as the tool surface 13. Depending on the application, up to nine laser beams can be used as partial beams. In the example shown, pulsed laser radiation with temporal pulse durations of 1 ps, i.e. ultrashort pulses, and with a pulse energy of 100 μJ is used. The two partial beams 17, 18 directed in the direction of the tool blank 11 are oriented at a finite angle to one another such that the partial beams 17, 18 interfere with one another in an interference region 19. The tool blank 11 is arranged in the laser machining device 14 such that the interference region 19 is arranged substantially on the top surface 13 of the tool blank 11 as a working surface. The interference pattern formed by the interfering partial beams 17, 18 depends substantially on the angle formed by the partial beams 17, 18, their polarization and the wavelength of the laser radiation used, so that by changing these parameters the interference pattern can be adapted as required. The top surface 13 of the tool blank 11 is structured by the incident partial beams 17, 18 that interfere with one another, wherein the structuring substantially corresponds to the intensity maxima of the interference pattern. By using ultrashort pulsed laser radiation, the tool 10 is substantially structured, and thus produced, purely ablatively, i.e. without heat being introduced into the top surface 13 of the tool blank 11, since the pulse duration of the laser radiation is so short that no thermal interaction between the laser radiation and the material of the tool blank 11 occurs. In this respect, this type of machining is also called cold ablation. This allows comparatively fine structural patterns to be realized in the micro- and/or nanoscale range while simultaneously avoiding thermal damage to the tool. Due to the partial beams 17, 18 that interfere with one another, topographical structures are formed in the interference region 19 so as to structure the top surface 13 of the tool blank 11. In the example shown, 50 pulses are superimposed for structuring purposes.

If structuring of the tool blank 11 beyond the interference region 19 of the partial beams 17, 18 is desired, the tool blank 11 can be moved relative to the interference region 19, which includes movements in a translational and/or rotational manner and is illustrated by the arrows shown in gray in FIG. 1. For this purpose, the laser machining device 14 is designed such that the interference region 19 of the partial beams 17, 18, which in this respect corresponds to a region of focus, is movable relative to the top surface 13 of the tool blank 11 to be structured. For example, this is done by deflecting the two partial beams 17, 18 via mirrors actuated by servo motors in the sense of an F-Theta lens. Alternatively or additionally, the tool blank 11 can be moved in a translational manner, for example by linear guides. Via a corresponding guide, rotation of the tool blank 11 relative to the laser machining device is also possible in this way, in particular about its axis of extension. By moving the interference region 19 relative to the top surface 13 of the tool blank 11, structuring of the top surface 13 beyond the interference region 19 is possible by successively machining the top surface 13 via the interfering partial beams 17, 18, in particular by scanning part or all of the surface thereof.

In the example in FIG. 1, the structuring leads to a tool profile 20 of the tool 10, thus to a surface topography, with linear structural elements 21, which are shown greatly enlarged in the right-hand illustration in FIG. 1 for reasons of clarity. The tool profile 20 of the top surface 13 of the tool 10 perpendicular to the direction of extension of the structural elements 21 approximately corresponds to a sinusoidal course, in which indentations 22 and elevations 23 of equal size are arranged one behind the other at a fixed distance Δd, which is referred to as the lateral period in the sense of the invention, and wherein there is a continuous transition between each of the indentations 22 and elevations 23; this is illustrated in FIG. 1 by solid lines. The lateral period Δd between an indentation 22 and an indentation 22 adjacent thereto is 10 μm in the example shown. The elevations 23 are arranged in the same lateral period Δd. The tool 10 shown on the right in FIG. 1 is provided with linear structural elements 21 over its entire top surface 13 and is thus finished.

The finished tool 10 shown on the right in FIG. 1 is then used as a stamping tool or die in a stamping device and is placed opposite the workpiece 12 to be machined so that the top surface 13 of the tool 10 faces the workpiece 12. In the example in FIG. 2, the workpiece 12 is a sheet of brass (CuZn30). By pressing the tool 10 having the above-mentioned tool profile 20 onto the workpiece 12 with a contact pressure of 1,500 MPa, thus along a machining axis 24 arranged perpendicularly to the workpiece surface 13, the tool profile 20 is at least partially molded onto the workpiece 12 as a plastic deformation, wherein the workpiece 12 is provided with a workpiece profile 25 which corresponds, at least in some regions, to the tool profile 20, in particular is at least partially complementary thereto. In the left-hand illustration in FIG. 2, the machining axis 24 is indicated by a large gray arrow. In the example shown, full-surface structuring of the workpiece 12 is desired, wherein the structured top surface 13 of the tool 10 is significantly smaller than the surface of the workpiece 12 to be structured. Therefore, after this machining step, the tool 10 is moved relative to the workpiece 12, after which stamping is carried out again with the aforementioned contact pressure. This process is then repeated until the entire surface of the workpiece 12 is structured. This process is also called stitching and is illustrated in the left-hand illustration by the small gray arrows. The finished structured workpiece 12 is shown on the right in FIG. 2, from which it can be seen that the workpiece profile 25 is at least partially complementary to the tool profile 20 by the workpiece profile 25 having indentations 22 which are arranged in the same lateral period Δd as the indentations 22 of the tool profile 20.

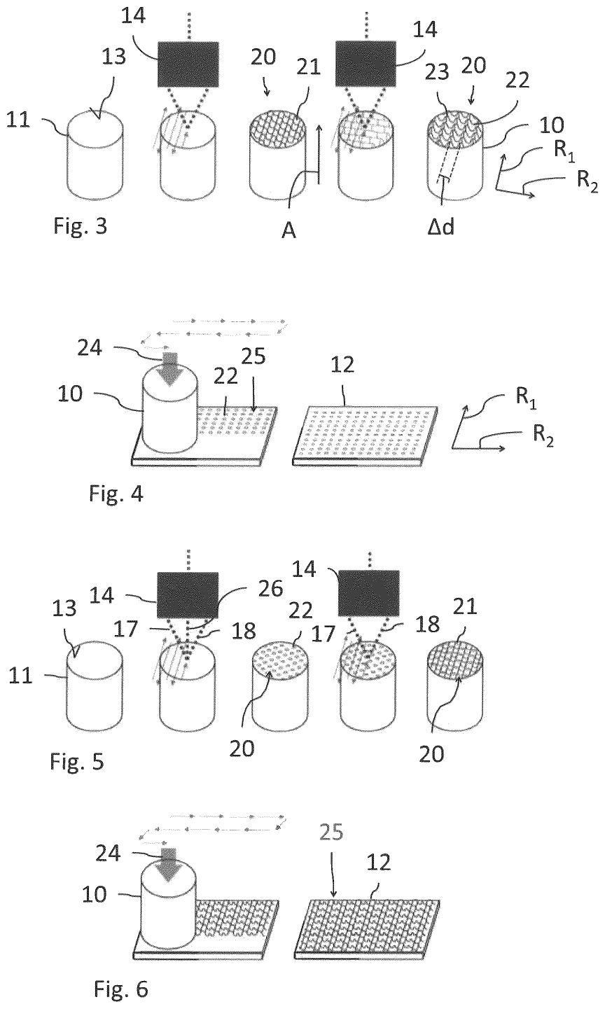

FIG. 3 shows a further possibility for producing a tool 10 having a tool profile 20 which differs from that in the example in FIG. 1. For this purpose, similarly to the example in FIG. 1, the entire top surface 13 of the tool 10 in the form of a tool blank 11 is first provided with a tool profile 20 having linear structural elements 21 as first indentations 22 via the laser machining device 14, and therefore reference is made to the above statements in this regard to avoid repetition. In contrast to the example in FIG. 1, the pulse energy of the laser radiation is 80 μJ and 20 individual pulses are superimposed for structuring purposes. The resulting first tool profile 20 in the third illustration in FIG. 3 is qualitatively similar to the tool profile 20 according to FIG. 1, but has, in contrast thereto, a smaller lateral period Δd of 6 μm. After this first structuring process, the tool 10 is rotated by 90° about its axis of extension A when transitioning from the third representation to the fourth representation in FIG. 3 and is again provided in the laser machining device 14 so that further structuring of the entire top surface 13 is subsequently carried out with the same parameters as the first structuring process.

As a result, the tool 10 shown on the right in FIG. 3 has a tool profile 20 with columnar structuring comprising elevations 23 which are arranged one behind the other in a first direction R₁ with a first lateral period Δd of 6 μm and which are also arranged one behind the other in a second direction R₂, which is perpendicular to the first direction R₁, with a second lateral period Δd also of 6 μm. Since each two adjacent elevations 23 of the tool profile 20 are separated by an indentation 22, the tool profile 20 has first indentations 22 in the first direction R₁ arranged in the first lateral period Δd, and second indentations 22 in the second direction R₂, which are arranged in the second lateral period Δd, wherein only one lateral period Δd is shown in FIG. 3. The region of the second indentations 22 overlaps the region of the first indentations 22 and the first indentations and the second indentations 22 are created in separate work steps.

According to FIG. 4, the tool 10 shown on the right in FIG. 3 is placed opposite the workpiece 12 to be machined as a die, wherein the top surface 13 faces the workpiece 12. The workpiece 12 is machined by the tool 10 at a contact pressure of 1,200 MPa along the machining axis 24 so that the columnar tool profile 20 is molded onto the workpiece 12 so as to partially complement it, with the result that the workpiece 12 has a workpiece profile 25 having indentations 22, which, similarly to the elevations 23 of the tool 10, are each arranged one behind the other in two directions R₁, R₂ that are perpendicular to one another in a lateral period Δd of 6 μm. The entire surface of the workpiece 12 is machined as already described in connection with FIG. 2 in the sense of stitching, which is illustrated by the gray arrows in the left-hand illustration in FIG. 4. The right-hand illustration in FIG. 4 shows the workpiece 12 machined over its entire surface by the tool 10, which workpiece has the workpiece profile 25 already mentioned.

In the example in FIG. 5, the structuring of the tool 10 as a tool blank 11 takes place in two machining steps, similarly to the example in FIG. 3. First, the cylindrical tool blank 11 made of a tungsten carbide-cobalt hard metal (WC—Co) is provided in the laser machining device 14, which structures the top surface 13 of the tool blank 11 with a first group of indentations 22 in a first machining step. This first machining step is carried out by laser radiation with a pulse duration of 100 fs and a pulse energy of 20 μJ, wherein three partial beams 17, 18, 26 interfere with one another and ten individual pulses are superimposed. Thereafter, the laser machining device 14 is moved relative to the tool blank 11 in such a way that structuring takes place again until the entire top surface 13 of the tool blank 11 is structured and the tool profile 20 shown in the central illustration in FIG. 5 is formed. Due to the structuring parameters mentioned, the tool profile 20 has, after structuring of the tool 10, a periodic arrangement of indentations 22, which are also called sinks, wherein the tool profile 20 has three axes along the top surface 13 of the tool 10, along which the indentations 22 are arranged in the same lateral period Δd each time, wherein the lateral periods Δd of the indentations 22 are each 1 μm. Within the sense of the invention, this arrangement of indentations 22 is also referred to as a hexagonal arrangement. The tool 10 structured over its entire surface after the first work step is shown in the central illustration in FIG. 5, wherein the dimensions of the indentations 22 are not shown to scale but greatly enlarged for reasons of clarity.

In a subsequent work step, the tool profile 20 is provided with further structuring, the region of which overlaps the region of the first structuring. For this purpose, the parameters of the laser machining device 14 are changed so that the second structuring is formed via laser radiation with a pulse duration of 100 fs, a pulse energy of 30 μJ and by two laser beams 17, 18 that interfere with one another, wherein the structuring is formed by superimposing ten pulses before the laser machining device 14 is moved relative to the tool 10 in the manner already mentioned in order to structure the entire surface of the tool 10. The second tool structuring results in the formation of linear structural elements 21 in the form of indentations 22, which are arranged one behind the other in a lateral period Δd of 2 μm. By superimposing the first structuring with the hexagonally arranged indentations 22 in a—first—lateral period Δd of 1 μm with the second structuring comprising linear structural elements 21 in a—second—lateral period of 2 μm, the tool profile 20 comprises periodic, but at the same time also hierarchical structuring, which is shown in the right-hand illustration in FIG. 5, and which has the linear indentations 22 according to the second structuring as the dominant element, wherein, in the regions not machined during the second structuring process, the hexagonal arrangement of the indentations 22 according to the first structuring is formed having a smaller lateral period Δd compared to the second structuring.

After the tool profile 20 has been provided with the hierarchical structuring according to the right-hand illustration in FIG. 5, the tool 10 is placed opposite a sheet of brass (CuZn30) to be stamped as the workpiece 12. The tool 10 then applies a contact pressure of 3,500 MPa along the machining axis 24 to the workpiece 12, wherein the tool 10 is vibrated as a die at a frequency in the ultrasonic range in order to optimize the molding process. This results in the tool profile 20 being completely molded onto the workpiece 12, which thus has a workpiece profile 25 that is complementary to the tool profile 20. Due to the smaller surface of the tool 10 compared to the surface of the workpiece 12, full-surface structuring of the workpiece 12 is carried out by successively moving the tool 10 relative to the workpiece 12 in the sense of the stitching process already mentioned, which is shown in the left-hand illustration in FIG. 6 by the gray arrows. The finished workpiece 12 structured over the entire surface thereof is shown on the right in FIG. 6, wherein the workpiece profile 25 is designed to be complementary to the tool profile 20, as already mentioned.

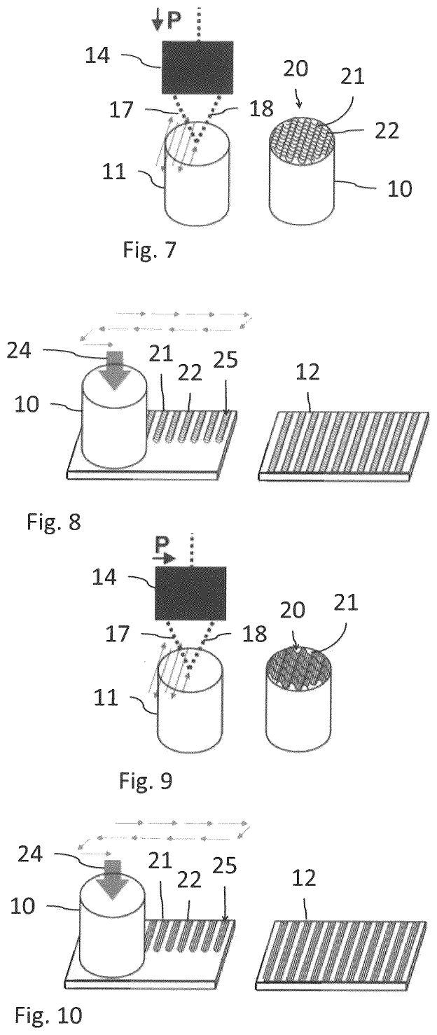

FIG. 7 shows an example of the method for producing the tool 10 by structuring a cylindrical tool blank 11 made of a tungsten carbide-cobalt hard metal (WC—Co), in which the latter is provided in the laser machining device 14 in a similar manner to in the previous examples. Structuring is carried out using linearly polarized laser radiation with a pulse duration of 5 ps and a pulse energy of 50 μJ, wherein 200 pulses are superimposed for structuring purposes. According to the left-hand illustration in FIG. 7, it can be seen that the structuring is carried out via two partial beams 17, 18 which interfere with one another, wherein the linear polarization P of the partial beams 17, 18 is selected in each case such that the polarization plane is parallel to the top surface 13 of the tool blank 11 to be structured. Due to the structuring of the tool blank 11, the tool profile 20 has sinusoidal, linear structural elements 21 as a group of indentations 22, which are arranged one behind the other in a lateral period Δd of 6 μm, similarly to in the example in FIG. 1.

In the example in FIG. 7, this—primary—structuring is superimposed by a further—secondary—structuring, which is formed due to the polarization of the partial beams 17, 18 interfering with one another. This secondary structuring is formed due to the linear polarization of the partial beams 17, 18 described above and causes the additional generation of structural elements 21, which are also linear, as a further group of indentations 22, which have structural sizes, in particular a lateral period Δd, which approximately corresponds at most to the wavelength of the laser radiation used. The indentations 22 of the secondary structuring are arranged substantially at an angle of 0° to the linear polarization of the partial beams 17, 18 and at an angle of 90° to the indentations 22 of the primary structuring. The directions of extension of the linear structural elements 21 of the secondary structuring are therefore substantially perpendicular to the polarization of the partial beams 17, 18. The generation of the first group of indentations 22 as primary structuring and the second group of indentations 22 takes place in a single work step by the above-mentioned superposition of 200 pulses and due to the polarization of the partial beams 17, 18. The entire surface of the tool 10 is structured in the manner already mentioned; the tool 10 with structuring over the entire surface thereof is shown in the right-hand illustration in FIG. 7.

Using the tool 10 produced according to FIG. 7, a sheet of brass (CuZn30) is then machined as a workpiece 12 according to the left-hand illustration in FIG. 8 by pressing the tool 10, as a die, onto the workpiece 12 with a contact pressure of 2,000 MPa along the machining axis 24, wherein at the same time the tool 10 is vibrated along the machining axis 24 at frequencies in the ultrasonic range in order to optimize the molding process. The entire height of the tool profile 20 is thus not molded; rather, said profile is only partially molded as a complementary structure onto the workpiece profile 25, wherein the workpiece profile 25 has the primary structuring comprising the linear structural elements 21 arranged one behind the other in a lateral period Δd of 6 μm and also the secondary structuring superimposed therewith having the linear structural elements 21 arranged perpendicularly to the first structuring having dimensions that are substantially smaller than the wavelength of the laser radiation. To the applicant's knowledge, the creation of this—superimposed—structuring as the workpiece profile 25 on brass (CuZn30) is not possible with direct machining using laser radiation, but only with the molding process described above, since in the latter case no melting dynamics occur when creating the structuring on the workpiece profile. The machining of the workpiece 12, thus the creation of the superimposed structuring on the workpiece profile 25, takes place in a single pressing or stamping step. The entire surface of the workpiece 12 is then structured in the sense of stitching, as already described. The workpiece 12 is shown on the right in FIG. 8 with structuring over the entire surface thereof.

FIG. 9 shows an example of the invention, in which the tool blank 11 is structured analogously to the example in FIG. 7, in particular also by laser radiation with a pulse duration of 5 ps and a pulse energy of 50 μJ. Structuring is carried out via two partial beams 17, 18 that interfere with one another, wherein the linear polarization P of the partial beams 17, 18 is selected each time such that the polarization axes of the partial beams 17, 18 again each form an angle of 0° to the top surface 13 of the tool blank 11 to be structured; in the example in FIG. 7, the polarization axes of the partial beams 17, 18 are therefore each parallel to the top surface 13 of the tool blank 11 and also perpendicular to the polarization axes of the partial beams 17, 18. Analogous to the example in FIG. 7, the tool blank 11 is structured by the superposition of 200 laser pulses. The tool 10 is shown on the right in FIG. 9 with structuring over the entire surface thereof, wherein its tool profile 20 has a primary structuring with a first group of sinusoidal, linear structural elements 21 as indentations 22, which are arranged in a lateral period Δd of 6 μm, and in this respect corresponds to the primary structuring in the example according to FIG. 7. Due to the linear polarization P of the partial beams 17, 18, the tool profile 20 has a secondary structuring with linear structural elements 21 which are superimposed on the primary structure and which are of an order of magnitude that does not exceed the wavelength used. Due to the orientation of the linear polarization vectors P of the partial beams 17, 18, the secondary structuring comprising the linear structural elements 21 as indentations 22 is parallel to the direction of extension of the primary structuring and thus perpendicular to the secondary structuring in the example according to FIG. 7. The tool blank 11 is structured, including the primary and secondary structuring, in a single work step. FIG. 9 shows the tool 10 with structuring over the entire surface thereof on the right.

With the tool 10 produced according to FIG. 9, according to FIG. 10, the workpiece 12, here, for example, a sheet of brass (CuZn30), is machined and structured, wherein the structuring is carried out by a contact pressure between the tool 10 and the workpiece of 2,000 MPa along the machining axis 24 and simultaneous vibration of the tool 10 along the machining axis 24 with a vibration frequency in the ultrasonic range. This results in the tool profile 20 being partially molded onto the workpiece profile 25, wherein the workpiece profile 25 has a structure that is complementary to the tool profile 20 so that reference is made in this regard to the above description of the tool profile 20 according to FIG. 9. The entire surface of the workpiece 12 is machined via the stitching process already described, which is shown by the gray arrows in the right-hand illustration in FIG. 10. The workpiece 12 is shown on the right in FIG. 10 with structuring over the entire surface thereof.

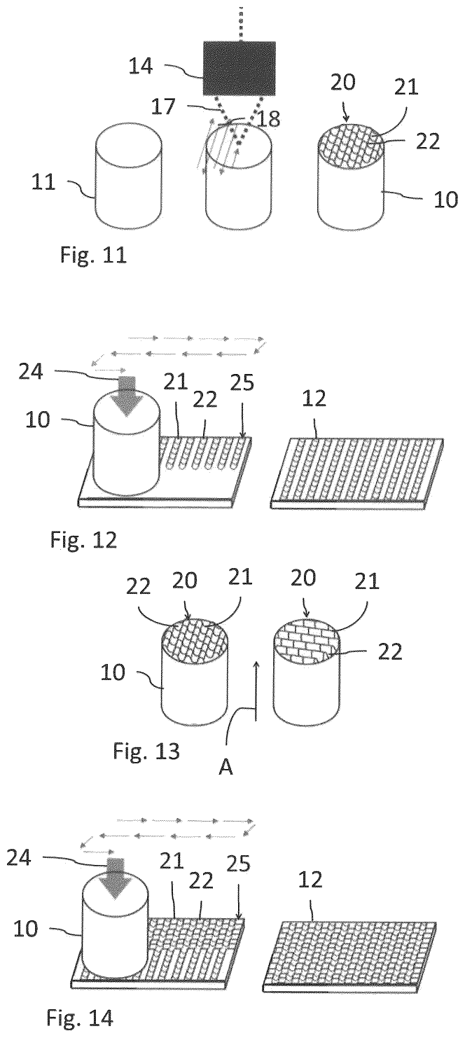

FIGS. 11 to 14 show further examples of the invention. According to FIG. 11, a tool blank 11 made of a tungsten carbide-cobalt hard metal (WC—Co) is provided, analogously to the example in FIG. 1, with a tool profile 20 having linear structural elements 21 as indentations 22 with a lateral period Δd of 10 μm. With the tool 10 thus produced, a sheet of brass (CuZn30) as the workpiece 12 is then machined over the entire surface thereof in a first machining step, as already described in connection with FIG. 2, wherein, unlike in the example in FIG. 2, a contact pressure of 1,000 MPa is now used along the machining axis 24. The workpiece 12 is shown on the right in FIG. 12 with structuring over the entire surface thereof.

After the entire surface of the workpiece 12 has been structured, the tool 10 is rotated by 90° about its axis of extension A according to FIG. 13 such that the linear structural elements 21 are now perpendicular to the structural elements 21 of the workpiece 12. This is shown in the right-hand illustration in FIG. 13. In this orientation, the tool 10 applies a contact pressure of 1,000 MPa along the axis of extension 24 to the workpiece 12 in a second machining step so that superimposed structuring of the workpiece 12 is formed as a workpiece profile 25, which can be seen as a checkerboard pattern in the example shown. The left-hand side of FIG. 14 shows the workpiece 12, the surface of which has not yet been completely structured in the second machining step. The full-surface structuring of the workpiece 12 is achieved by the stitching process already explained; the workpiece 12 is shown on the right in FIG. 14 with structuring over the entire surface thereof. The—superimposed—structuring of the workpiece profile 25 is therefore obtained by a single tool 10 having a single, primary structuring in two successive machining steps, wherein the tool 10 is rotated by 90° about its axis of extension A between the machining steps.

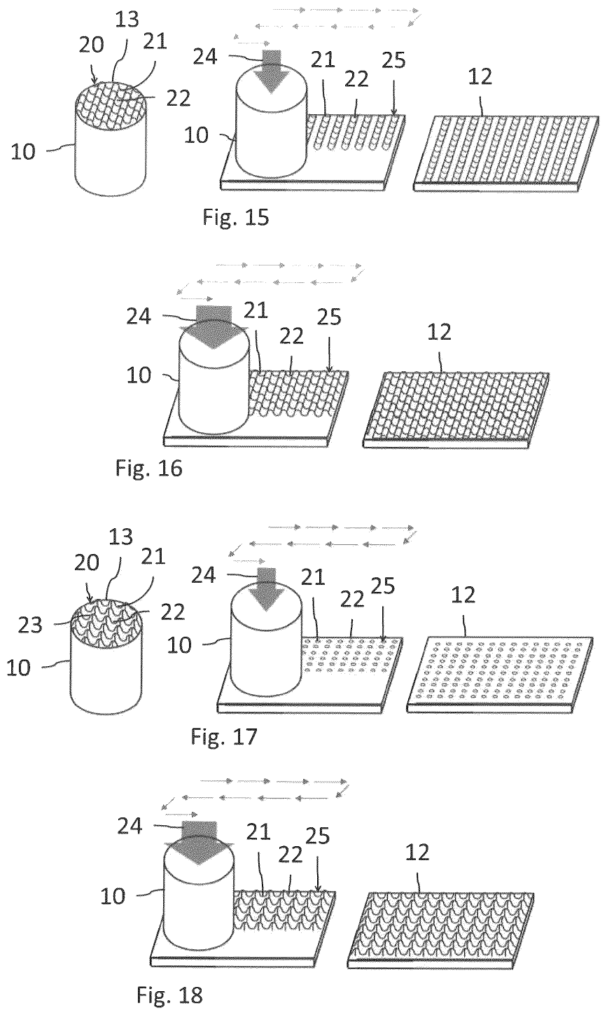

FIGS. 15 and 16 show a further example of the invention, which is based on a tool 10 according to FIG. 1 with a fully structured surface and which is shown in the left-hand illustration in FIG. 15. In this respect, the tool profile 20 has linear structural elements 21 as indentations 22 with a depth of 10 μm with respect to the unstructured region of the top surface 13, wherein the indentations 22 are arranged one behind the other in a lateral period Δd of 10 μm. A sheet of brass (CuZn30) as the workpiece 12 is subjected to a first contact pressure of 1,500 MPa along the machining axis 24 by the tool 10 produced in this way, which is shown in the central illustration in FIG. 15. As a result, the tool profile 20 is not completely molded onto the workpiece profile 25, with only half of the structural depth of the tool profile 20, which is referred to as the machining depth within the sense of the invention, being molded. The machining depth therefore does not correspond to the complete depth of the indentations 22 of the tool profile 20. As a result, the workpiece profile 25 has comparatively sharp-edged plateaus with a width of 5 μm each, which are separated from one another by grooves in the form of indentations having a width of 5 μm and a depth of 5 μm. To the applicant's knowledge, such a workpiece profile 25 cannot be produced by direct structuring using laser radiation, since the melting dynamics that occur in this case lead to rounding of the workpiece profile and impair it. The full-surface structuring of the workpiece 12 is carried out by stitching; the workpiece 12 is shown on the right in FIG. 15 with structuring over the entire surface thereof.

FIG. 16 illustrates a further example of the process of machining a sheet of brass (CuZn30) as the workpiece 12 using the workpiece 12 shown on the left in FIG. 15, wherein the workpiece 12 is structured at a contact pressure of 3,500 MPa along the machining axis 24, which contact pressure is greater than in the method in FIG. 15, and with simultaneous vibration of the tool 10 as a die with frequencies in the ultrasonic range along the machining axis 24. This results in the tool profile 20 being completely molded onto the workpiece profile 25 so that the complete structural depth of 10 μm of the tool profile 20 is molded. The machining depth in the method according to FIG. 16 is therefore greater than the machining depth in the method according to FIG. 15 due to the greater contact pressure. As a result, the workpiece profile 25 has a structure having sinusoidal, linear structural elements 21 which have a depth of 10 μm and a lateral period Δd of 10 μm. In this respect, the workpiece profile 25 corresponds to, in particular complements, the tool profile 20. The full-surface structuring of the workpiece 12 is carried out by stitching and is ultimately shown on the right in FIG. 16.

FIGS. 17 and 18 illustrate a further example of the method according to the invention for machining a workpiece 12, which is, for example, a sheet of brass (CuZn30). The tool 10 used for this purpose is arranged on the left in FIG. 17 and has a tool profile 20 having full-surface structuring with columnar elevations 23, wherein an indentation 22 is formed as a structural element 21 between two adjacent elevations 23. The indentations 22 themselves are arranged periodically one behind the other in two directions perpendicular to one another. In this respect, the tool profile corresponds to that in the example according to FIG. 3. Quantitatively and in contrast to the example in FIG. 3, the indentations 23 each have a depth of 10 μm with respect to the unstructured region of the workpiece 10 and are arranged one behind the other in lateral periods Δd of 10 μm each.

According to the central illustration in FIG. 17, the tool 10 is pressed onto the workpiece 12 as a die with a—comparatively low—contact pressure of 1,200 MPa along the machining axis 24 so that, as already described, the tool profile 20 is only partially molded onto the workpiece profile 25. In the present example, the tool profile 20 is only molded as far as half of the structural geometry of 10 μm, which corresponds to the machining depth. This results in the workpiece profile 25 having sharp-edged indentations 22 with a diameter of 5 μm, wherein the indentations 22 are arranged in a cubic periodic pattern. To the applicant's knowledge, such workpiece profiles 22, in particular their sharp-edged indentations 22, cannot be produced by direct laser structuring. The full-surface machining of the workpiece 12 is carried out by stitching, as already described. The workpiece 12 is shown on the right in FIG. 17 with structuring over the entire surface thereof.

In FIG. 18, another sheet of brass (CuZn30) is machined and structured as the workpiece 12 using the die as the tool 10 according to FIG. 17, wherein, in contrast to FIG. 17, a comparatively high contact pressure of 3,500 MPa along the machining axis 24 is used with an additional vibration of the tool 10 during the stamping process with frequencies in the ultrasonic range in order to mold the tool profile 20 onto the workpiece profile 25 as completely as possible. In the present example, the tool profile 20 is molded to the complete structural depth of 10 μm so that the tool profile 25 ultimately has a columnar topography whose indentations 22 have a depth of 10 μm and are arranged one behind the other in two lateral periods Δd of 10 μm each, which are arranged perpendicularly to one another. The workpiece profile 25 is thus designed to complement the tool profile 20. The workpiece 12 is machined over its entire surface via stitching, as already described and indicated in the left-hand illustration in FIG. 18 by the gray arrows. The workpiece 12 that has been machined over the entire surface thereof is shown on the right in FIG. 18.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a tool to machine a workpiece, in particular a punching or forming tool, the method comprising:
providing a metal tool blank in a laser machining device; and
structuring, via the laser machining device, a tool surface of the tool blank via interference of at least two laser beams, the at least two laser beams having at least temporary pulse durations of at most 15 ps,
wherein a tool profile having at least one indentation is produced on the tool surface by the structuring.

2. The method according to claim 1, wherein the at least one indentation is produced with a dimension or with a depth with respect to an unstructured region of the tool surface of between 10 nm and 50 μm or between 100 nm and 15 μm.

3. The method according to claim 1, wherein at least two indentations having substantially identical dimensions or having substantially identical depths are produced.

4. The method according to claim 1, wherein at least one group of indentations is produced in a periodic pattern on the tool surface.

5. The method according to claim 4, wherein the group of indentations in the periodic pattern on the tool surface is produced having a lateral period between 10 nm and 50 μm, or between 100 nm and 15 μm in at least one direction along the tool surface.

6. The method according to claim 1, wherein at least one group of indentations is produced on the tool surface having a linear course and/or a rectangular, square, basic shape and/or a circular basic shape.

7. The method according to claim 1, wherein at least two first indentations or a first group of indentations are produced having a first lateral period between 10 nm and 50 μm or between 100 nm and 15 μm, wherein at least two second indentations or a second group of indentations are produced having a second lateral period, and wherein the second lateral period is smaller than the first lateral period.

8. The method according to claim 7, wherein the region of the second indentations or the second group of indentations at least partially overlaps the region of the first indentations or the first group of indentations.

9. The method according to claim 7, wherein the first indentations or the first group of indentations and the second indentations or the second group of indentations are created in a single work step or in separate work steps.

10. The method according to claim 9, wherein the first indentations or the first group of indentations are produced via interference of the at least two laser beams, and wherein the second indentations or the second group of indentations are created via interference of at least two laser beams and/or via a single laser beam.

11. The method according to claim 1, wherein the tool blank is coated before being structured and/or wherein the tool is coated after being structured.

12. A tool, in particular a punching or forming tool, structured in accordance with the method according to claim 1.

13. The tool according to claim 12, wherein the tool has at least one component made of a hard metal which has a plurality of hard material particles and a binder matrix, and/or at least one component made of a thermally treated tool steel.

14. The tool according to claim 12, wherein the tool has a hard material layer, or a carbon layer, or a tetrahedral, hydrogen-free carbon layer, at least in some regions of the tool surface.

15. A method for machining a workpiece via a tool according to claim 12, the method comprising:
plastically deforming the workpiece at least in some regions via the tool; and
providing the tool with a workpiece profile which corresponds to the tool profile, at least in some regions.

16. The method according to claim 15, wherein the workpiece is plastically deformed via the tool in at least two machining steps, the tool plastically deforming the workpiece along a machining axis with a first machining depth in a first machining step and, in a second machining step, the tool plastically deforming the workpiece along the machining axis with a second machining depth, and wherein the first machining depth differs from the second machining depth.

17. The method according to claim 16, wherein the first machining step is carried out using a first tool and the second machining step is carried out using a second tool.

18. The method according to claim 17, wherein the second tool has a periodic structure having a lateral period which is smaller than the lateral period of the periodic structure of the first tool.

19. The method according to claim 16, wherein the press-in pressure in one machining step differs from the press-in pressure in another machining step.

20. The method according to claim 15, wherein the workpiece is plastically deformed via a vibrational movement of the tool along the machining axis, or wherein the workpiece is machined via the tool at a temperature of at most 1200° C., without any heat being externally input.
